(19) United States
(12) Patent Application Publication
(10) Pub. No.: US 2011/0268247 A1
(43) Pub. Date: Nov. 3, 2011

(54) MULTI-PROFILE PENETRATING RADIATION IMAGING SYSTEM

(75) Inventors: Daniel Shedlock, Knoxville, TN (US); Paul Ridgeway, Knoxville, TN (US); Steve Dylewski, Knoxville, TN (US)

(73) Assignee: NUCSAFE, INC., Oak Ridge, TN (US)

(21) Appl. No.: 12/771,719

(22) Filed: Apr. 30, 2010

(51) Int. Cl. G01N 23/04

(52) U.S. Cl. 378/62

(57) ABSTRACT

Systems for scanning an object are disclosed. Such systems typically are used to inspect various objects with equipment that produces an image of the object based on penetrating radiation. Examples are X-Ray imaging, infrared imaging, terahertz imaging, and radar imaging. The systems typically include a radiation source and a rotating collimator for generating a beam of energy. A detection array is provided for detecting imagery elements from the beam of energy. A motion controller is provided for instructing a positional driver system to move the radiation source, the rotating collimator and the detector system to the plurality of locations about a support structure. The motion controller may also instruct the positional driver system to turn, oscillate, or otherwise maneuver a portion of the imaging system to the virtually limitless orientations made possible by the disclosed embodiments.

### FIELD

This disclosure relates to the field of systems for energy beam imaging systems.

### BACKGROUND

It is often desirable to inspect various objects with equipment that produces an image of the object based upon a particular electromagnetic spectrum or other penetrating radiation. Examples are X-ray imaging, infrared imaging, terahertz imaging, and radar imaging. Such systems often employ an electro-mechanical apparatus to scan the object with an energy beam and produce a raster image of the object.

Compton backscatter imaging (CBI) is a single-sided imaging technique in which an X-ray radiation source and the detection/imaging device are located on the same side of the object. As a result, CBI is a valuable non-destructive inspection (NDI) tool because of its single-sided nature, the penetrating abilities of radiation, and unique interaction properties of radiation with matter. Changes in the backscatter photon field intensity (resulting in contrast changes in images) are caused by differences in absorption and scattering cross sections along the path of the scattered photons. Since the inception of CBI, a diverse set of imaging techniques have evolved using both collimated and un-collimated detectors, coded apertures, and hard X-ray optics. Specific examples of such detectors, coded apertures, and X-ray optics are well-known to a person having ordinary skill in the art and, therefore, will not be discussed in detail here. “Pencil beam” CBI uses a highly collimated beam of penetrating radiation to interrogate objects. The pencil beams may vary in diameter from microns to centimeters, but usually consist of a near-parallel array of photons forming a tight beam. A common implementation uses rotating collimators, which rotate about an axis of rotation and sweep one or more pencil beams across an object in an inspection area. A detector measures the backscatter from the CBI pencil beam as it scans the object.

Transmission X-ray inspection systems use an X-ray beam that penetrates one side of an object to be inspected and detectors on the opposite side detect the amount of energy transmitted through the object at an array of locations in order to compile an image or other data regarding the internal structure of the object. Computed tomography (CT) imaging is a technology used to generate a three-dimensional image of the inside of an object from a large series of two-dimensional X-ray images taken around a single axis of rotation.

Typically inspection systems are highly customized for particular objects that are to be inspected. For example X-ray baggage inspection stations, X-ray portal inspection stations, X-ray inspection stations for manufactured components, and X-ray food inspection stations are all configured differently even though they may use many of the same or similar components. Reconfiguring and inspection system designed for one purpose or using one penetrating radiation technology into an inspection system for a different purpose or for using a different penetrating radiation technology is difficult and expensive and in many cases may not be practical, even though in some cases it may be desirable to do so. What is needed therefore is a new systems approach for scanning systems that provides greater operational flexibility and adaptability.

### SUMMARY

The present disclosure provides various embodiments of an apparatus for scanning an object. The apparatus includes modular, interchangeable components for single sided non-destructive inspection of a target object using one or more penetrating radiation emission and backscatter detection technologies. Typical embodiments include a penetrating radiation emission source, a data acquisition component in communication with a user interface component via a first generic communication protocol, and a motion control component including a motion controller, the motion control component in communication with the user interface component via a second generic communication protocol, wherein the data acquisition component is in communication with the motion control component via a third generic communication protocol, and wherein the data acquisition component and the motion control component are synchronized in response to a synchronization trigger signal.

In one embodiment, the data acquisition component further includes at least one detector for detecting penetrating radiation emitted from the penetrating radiation emission source. The motion control component may also further include a first motion controller and a second motion controller. In a related embodiment, the first generic communication protocol and the second generic communication protocol include TCP/IP protocol, USB protocol, and/or SPX/IPX protocol. In another related embodiment, the first generic communication protocol, the second generic communication protocol, and the third generic protocol include the same generic communication protocol. In yet another embodiment, the data acquisition component and the motion control component are synchronized by a synchronization signal protocol including TTL, RS-422/485, and/or RS-428. In certain embodiments, the penetrating radiation emission source includes an X-ray emission device including, in some cases for example, a collimator wheel.

In another embodiment, the data acquisition component, the motion control component, and the user interface component are each separately configured for the first motion controller, the second motion controller, a hardware synchronization trigger device, or an external input source to operate as a synchronization instruction source depending on instruction from the user interface component. In one version, the hardware trigger device includes a device selected from the group consisting of an optical trigger, a mechanical trigger, a magnetic trigger, a resolver, and an encoder.

In yet another embodiment, the imaging apparatus includes a scanning head for emitting penetrating radiation and detecting backscattered penetrating radiation, the scanning head including a penetrating radiation emission exit port and the at least one detector. In a related embodiment, the imagining apparatus further includes a cross beam including a first transport feature, wherein the scanning head is attached adjacent the first transport feature so that the scanning head is movable relative to the cross beam along the first transport feature in response to instruction from the motion control component. In one particular embodiment, the scanning head is attached adjacent the first transport feature via a movable joint wherein the scanning head is movable based on movement of the movable joint in response to instruction from the motion control component. The imaging apparatus may further include a gantry frame including the cross beam; a first side beam and a second side beam oriented substantially perpendicular to the cross beam wherein the side beams support the cross beam; and a plurality of support beams supporting the side beams; wherein the first side beam includes a second transport feature attached adjacent a first end of the upper cross beam, and wherein the second side beam includes a third transport feature attached adjacent a second end of the cross beam; and wherein the cross beam is movable relative to the first side beam and the second side beam in response to instruction from the motion control component. In certain embodiments, the scanning head further includes the penetrating radiation emission source.

In an alternative embodiment, the imaging apparatus includes a robotic arm including a first end wherein the scanning head is attached adjacent the first end of the robotic arm, wherein the movement of the robotic arm is controlled by the at least one motion controller. In a particular embodiment, the robotic arm includes at least three rotatable joints wherein substantially all Euler angles of rotation are achievable to position the scanning head for scanning a target object.

In one particular embodiment having a particular structural configuration, the imaging apparatus includes a cross beam including a first transport feature, wherein the penetrating radiation emission source is attached adjacent the first transport feature so that the penetrating radiation emission source is movable relative to the cross beam along the first transport feature in response to instruction from the motion control component. In one version, the at least one detector is attached adjacent the first transport feature so that the penetrating radiation emission source and the at least one detector are movable relative to the cross beam along the first transport feature in response to instruction from the motion control component.

In another version, the imaging apparatus further includes a scanning head for emitting penetrating radiation and detecting backscattered penetrating radiation, the scanning head including the at least one detector and the penetrating radiation emission source, wherein the scanning head is attached adjacent the first transport feature via a movable joint wherein the scanning head is movable based on movement of the movable joint in response to instruction from the motion control component. The imaging apparatus may further include, for example, a gantry frame including the cross beam; a first side beam and a second side beam oriented substantially perpendicular to the cross beam wherein the side beams support the cross beam; and a plurality of support beams supporting the side beams; wherein the first side beam includes a second transport feature attached adjacent a first end of the upper cross beam, and wherein the second side beam includes a third transport feature attached adjacent a second end of the cross beam; and wherein the cross beam is movable relative to the first side beam and the second side beam in response to instruction from the motion control component.

In another embodiment, an imaging apparatus is disclosed including modular, interchangeable components for single sided non-destructive inspection of a target object using one or more penetrating radiation emission and backscatter detection technologies, the imaging apparatus including a penetrating radiation emission source, a data acquisition component including one or more detectors, a motion control component including one or more motion controllers, a penetrating radiation emission exit port wherein penetrating radiation generated by the penetrating radiation emission source exits the imaging apparatus therefrom, a scanning head including the one or more detectors and the penetrating radiation emission exit port wherein the scanning head is movable in response to one or more signals from the one or more motion controllers, and a user interface component; wherein the data acquisition component, the motion control component, and the user interface component are configured for communication, including receiving and/or sending instruction sets, using a plurality of generic communication protocols whereby the scanning head can be integrated with various equipment configured for different motion profiles and communication protocols; wherein the data acquisition component, the motion control component, and the user interface component are configured for using a plurality of generic motion control standards; and wherein the data acquisition component and the motion control component are configured for using a plurality of generic synchronization protocols wherein each such synchronization protocol provides spatial and temporal control of the instruction sets in order to provide an accurate image of the scanned target object.

### BRIEF DESCRIPTION OF THE DRAWINGS

Various advantages are apparent by reference to the detailed description in conjunction with the figures, wherein elements are not to scale so as to more clearly show the details, wherein like reference numbers indicate like elements throughout the several views, and wherein:

FIG. 1 is block diagram of a scanning apparatus including coupled modules;

FIG. 2. is a block diagram of a scanning apparatus including decoupled modules;

FIGS. 3A-3F depict certain synchronizing signals between various elements of a scanning apparatus;

FIG. 4 depicts a somewhat schematic rotated side view of an apparatus including a gantry frame, the apparatus for scanning an object;

FIG. 5 depicts a somewhat schematic close-up rotated side view of a scanning head of the apparatus shown in FIG. 4;

FIG. 6 depicts a somewhat schematic close-up side view of a scanning head of the apparatus shown in FIGS. 4-5;

FIG. 7 depicts a somewhat schematic end view of the apparatus shown in FIGS. 4-6;

FIG. 8 depicts a somewhat schematic close-up perspective view of the apparatus shown in FIGS. 4-7;

FIG. 9 depicts a somewhat schematic rotated side view of a track-based apparatus for scanning an object;

FIG. 10 depicts a somewhat schematic perspective view of the apparatus shown in FIG. 9;

FIG. 11 depicts a somewhat schematic side view of the apparatus shown in FIGS. 9-10;

FIG. 12 depicts a somewhat schematic cross-sectional side view of the apparatus shown in FIGS. 9-11;

FIG. 13 depicts a somewhat schematic side view of an apparatus similar to the one shown in FIGS. 9-10, wherein the apparatus shown in this figure has no onboard motion controller;

FIG. 14 depicts a somewhat schematic perspective view of a scanning apparatus configured for scanning an object that moves relative to the scanning apparatus;

FIG. 15 depicts a somewhat schematic plan view of the scanning apparatus shown in FIG. 14;

FIG. 16 depicts a somewhat schematic perspective side view of a scanning apparatus including or otherwise attached to a robotic arm;

FIG. 17 depicts a somewhat schematic perspective view of the scanning apparatus shown in FIG. 16; and

FIG. 18 depicts a somewhat schematic side view of the scanning apparatus shown in FIGS. 16-17.

### DETAILED DESCRIPTION

In the following detailed description of the preferred and other embodiments, reference is made to the accompanying drawings, which form a part hereof, and within which are shown by way of illustration the practice of specific embodiments of systems for scanning an object. It is to be understood that other embodiments may be utilized, and that structural changes may be made and processes may vary in other embodiments.

The term “beam” or variations thereof is used herein in two different contexts including the context of (1) an embodiment of penetrating radiation or (2) an elongate structural member such as, for example, a portion of a gantry frame. Other terms used herein, unless otherwise specifically defined herein, are intended to retain their standard dictionary meaning(s) as understood with respect to the context in which such terms are used.

A “scanning apparatus” or “scanning system” is an apparatus that utilizes relative motion between one or more components and an object of interest to operate on some aspect of the object. For example, an inspection scanning system may employ an interrogation beam (such as an ultrasonic beam or an X-ray beam) that is moved over the surface of an article to be inspected. Scanning systems may use a variety of scanning motion profiles. One example of a scanning motion profile is a linear translation of a rotating collimated beam. Another example is an X-Y translation of a linearly-projected beam. A third example of a scanning motion profile is a motion of an object relative to a stationary beam. A fourth example is a beam that moves in a spiral pattern perpendicular to a surface of an object to be inspected, somewhat analogous to motion of a phonograph needle over a record, except that the inspection surface may not be planar. Another motion profile includes use of a robotic arm to sweep out conformal motion, or acquire data in a pattern that can be used for 3D imaging.

In many scanning systems the system that provides motion control is mechanically and electronically integrated with the data acquisition system. Disclosed herein are embodiments of an apparatus wherein these components are decoupled, thus permitting interchangeability between motion control component(s) and data acquisition component(s) without the need for re-engineering various components and/or sub-parts such as the scanning head and the detector system. As used herein the term “scanning head” refers to a portion of a scanning apparatus that either houses a device (such as an X-ray source and a rotating X-ray beam collimator) that generates scan line traces of a radiation and/or houses the part(s) of the scanning apparatus from which such penetrating radiation exits the apparatus, directed toward an object of interest. As used herein, the term “scan line trace” refers to a path of a scanning beam. The radiation produces imagery elements (such as Compton X-ray back-scattered radiation) that may be assembled into image scan lines. As used herein the term “image scan line” refers to a line element of an image produced using detector signals generated from a scan line trace.

As an example of interchangeability benefits of a decoupled scanning apparatus, in some embodiments the same scanning head may be used in different inspection configurations without re-engineering because in decoupled apparatuses position information may be generated by encoder output that is readable by different motion controllers. In addition to facilitating interchangeability, component decoupling also facilitates the optimization of such operational parameters as distance from beam source to object and scanning speed because different motion profiles may be easily provided with software (rather than hardware) modifications to effect changes in such parameters.

It is important to recognize that while many embodiments described herein depict configurations where the object being scanned remains stationary and the scanning head (and typically the detectors) are driven along a motion profile, the scope of the disclosure herein further includes configurations where both the scanning head and the object being scanned are both simultaneously driven along separate motion profiles. So, for example, references to positioning or moving portions of a scanning apparatus relative to an object being scanned includes configurations where the portions of the scanning apparatus move and the object remains stationary, and configurations where the object moves and the portions of the scanning apparatus remain stationary, and configurations where both the portions of the scanning apparatus move and the object moves.

Furthermore, while many of the embodiments disclosed herein use X-ray beams as the source of energy that produces data (typically including an image) from an object, in other embodiments a scanner may use beams from other portions of the electromagnetic spectrum (such as light beams, including laser beams) to produce data.

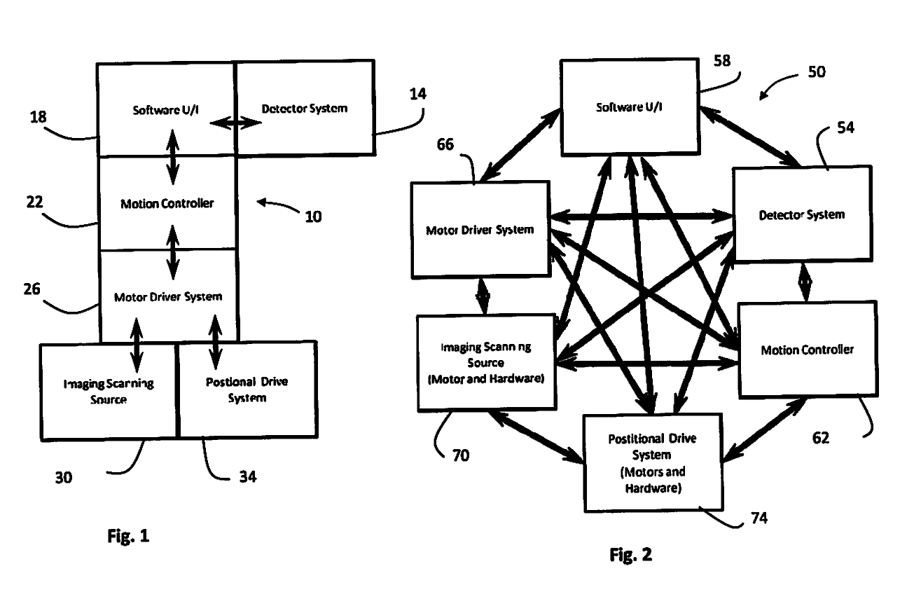

FIG. 1 illustrates a block diagram of a coupled scanning apparatus 10 for scanning an object. The scanning apparatus 10 includes six modules: a detector system 14, a software user interface 18, a motion controller 22, a motor driver system 26, a imaging scanning source 30, and a positional drive system 34. In the embodiment of FIG. 1 the detector system 14 is a radiation detector system, such as a Compton backscatter X-ray detector array. The software user interface 18 accepts user-input to initiate and, in some cases, control the scanning process and to generate imagery output. In some embodiments, some of the modules may be integrated into a single off-the-shelf module. For example, in one embodiment, a positioning system (e.g., a robot) includes a motion controller, a motor driver system, and a positioning system in one overall unit. In this example, the instruction set sent to the motion controller can come from either the software user interface or an ancillary motion controller taking instruction from the software user interface.

The motion controller 22 typically receives motion instructions from the software user interface 18. These instructions may be in various forms, such as incremental or absolute displacement vectors, speed commands and so forth. The motion controller 22 then converts these motion instructions into motor timing and drive levels that are sent to the motor driver system 26. The motor driver system 26 uses the motor timing and drive levels to provide power to motors in the positional drive system 34. This power may, for example, cause a rotating collimator in the imaging scanning source 30 to yaw, or may cause the imaging scanning source 30 and the detector system 14 to move to different locations relative to the object being scanned for data acquisition.

The imaging scanning source 30 typically uses an electric motor to spin a collimator that provides a rotating pencil beam. In such embodiments the motor driver system 26 may provide power to spin the rotating collimator or the motor driver system 26 may provide an on/off signal that turns on or off an external power source feeding the rotating collimator. The positional drive system 34 is essentially a system of motors and associated power transmission hardware. If the positional drive system 34 uses stepper motors then the motor driver system 26 may provide pulsed voltages to the stepper motors; if the positional drive system 34 uses servo motors then the motor driver system 26 may provide an electronic signal to the servo motors that provides instructions for a specific angular rotation of the servo motors. Motion can also be provided by means of driving a vehicle, linear actuator, one or more conveyor, or any position system that can provide the requisite relative motion.

Note that the term “positional drive system” as used herein refers to mechanisms that may provide rotational motions wherein substantially all Euler angles of rotation can be used for positioning, as well as motions in the traditional X-Y-Z linear translation directions. The “rotating collimator,” as the term is used herein, refers to a device that has built-in rotary motion for providing scan line traces of radiation that rotate around an axis. This spinning motion is distinct from the roll, pitch and yaw motions that may be provided by the “positional drive system.” However, a system can alternatively include, for example, a fixed beam with no rotational collimator, wherein all the positioning of the beam is provided by the positioning system.

The bi-directional arrows in FIG. 1 represent bi-directional communication links. In a coupled scanning apparatus such as the scanning system 10, each module (or “component”) communicates with only a few of the other modules. For example, the detector system 14 communicates only with the software user interface 18. The software user interface 18 communicates only with the detector system 14 and the motion controller 22. The various modules communicate using specific communication connection protocols and specific data transfer formats. A communication connection protocol is a set of standard rules for signaling, typically using a defined hardware interface. Communication connection protocols may also include standard rules for authentication and error detection. A data transfer format is a prescribed arrangement of bytes of data in data message that is communicated from one module to another module.

Typically in a coupled system such as scanning system 10, the communication connection protocol and the data transfer format for each bi-directional communication link is different from the communication connection protocols and data transfer formats of the other bi-directional communications links. Also, each communication connection protocol and data transfer format is often custom designed for the two specific manufacturers' modules that are communicating with each other. Because of this extensive customization it is very difficult to modify and adapt a coupled scanning system to a configuration and purpose for which it was not designed. For example a coupled system may employ manufacturer's proprietary connections between the motor driver system and the positional driver system. Consequently one may not randomly use one manufacturer's positional driver system with a different manufacturer's motor driver system. Furthermore, in a coupled system all of the other modules may be designed for use with that motor driver system and that positional drive system. Thus it may not be possible to replace a matched motor driver system/positional drive system combination with a different matched motor driver system/positional drive system combination, because the motion controller would also have to be replaced with one that is compatible with the new motor driver system/positional drive system combination.

FIG. 2 illustrates a decoupled scanning apparatus 50. The scanning apparatus 50 includes six modules: a detector system 54, a software user interface 58, a motion controller 62, a motor driver system 66, a rotating collimator 70, and a positional drive system 74. These modules may provide substantially the same functions as the modules of the same name in scanning system 10. However as indicated in FIG. 2, one principal difference between the decoupled scanning system 50 of FIG. 2 and the coupled scanning system 10 of FIG. 1 is that in a decoupled scanning system (such as scanning system 50) there is direct electronic communication between most or all modules. The direct electronic communication involves an exchange of data messages. The data messages may convey relatively simple information such as a synchronizing signal or the data messages may convey more complex information such as position encoder data.

In the embodiment of FIG. 2 each module has direct electronic communication with every other module, as indicated by the bi-directional arrows. As used herein the term “direct electronic communication” refers to electronic communication where data messages are conveyed between two modules without such data messages passing through at least one specified excluded module, and optionally where such data messages explicitly do pass through one or more specified included modules. Thus, if a scanning system comprises modules A, B, C, and D, the following statements represent examples of expressions defining direct electronic communication links:
1) “A direct electronic communication link for conveying data messages between module A and module B where the data messages do not pass through module C.”
2) “A direct communication link for conveying data messages between module A and module B where the data messages do not pass through module C or module D.”
3) “A direct communication link for conveying data messages between module A and module B where the data messages pass through module D but do not pass through module C.”
   Note that in example 1), the data messages conveyed between module A and module B may pass through module D, but do not necessary pass through module D.

One example of a direct electronic communication link for conveying data messages in a decoupled apparatus is a direct electronic communication link between the detector system and the motion controller where these data messages do not pass through the software user interface. Such data messages may convey a synchronizing signal that is used to time the starting or stopping of data (image) acquisition.

Another example of a direct electronic communication link for conveying data messages in a decoupled apparatus is a direct electronic communication link between the software user interface and the imaging scanning source where these data messages do not pass through the motion controller. Such data messages may convey imagery elements from the detector system that are assembled by the software user interface to form image scan lines. Alternately or in addition, such data messages may include at least one instruction selected from the group consisting of beam aperture size, power level, scanning speed, distance to sample, and resolution.

A further example of a direct electronic communication link for conveying data messages in a decoupled apparatus is a direct electronic communication link between the motion controller and the positional drive system where these data messages do not pass through the motor driver system. Such data messages may convey encoder position information.

Another example of a direct electronic communication link for conveying data messages in a decoupled apparatus is a direct electronic communication link for conveying data messages between the motion controller and the imaging scanning source where these data messages do not pass through the motor driver system. Such data messages may convey positional feedback information generated by a rotating collimator in the imaging scanning source so that the motion controller knows the rotational phasing of the rotating collimator.

Yet another example of a direct electronic communication link for conveying data messages in a decoupled apparatus may be used in systems where a motion controller has an on-board portion that is disposed adjacent the detector system and an outboard portion that is disposed adjacent the frame. Such embodiments may include a direct electronic communication link for conveying data messages between the outboard portion of the motion controller and the onboard portion of the motion controller where the second data messages do not pass through the software user interface. These data messages may represent synchronizing signals.

Further, some embodiments of decoupled scanning apparatuses utilize a motor driver system that has a translational portion that disposed adjacent the frame and a rotational portion that is disposed adjacent the imaging scanning source. Such embodiments may employ a second direct communication link for conveying second data messages between the motion controller and the translational portion of the motor driver system where the second data messages do not pass through the rotational portion of the motor driver system, and a third direct communication link for conveying third data messages between the motion controller and the rotational portion of the motor driver system where the third data messages do not pass through the translational portion of the motor driver system. These second data messages and third data messages may include such operational information as on/off switching signals, power level signals, or power polarity signals.

Some embodiments of decoupled apparatuses include an external synchronization source for providing a fixed interval clock signal. Such embodiments may employ a direct electronic communication link for conveying data messages that include the fixed interval clock signal between the external synchronization source and the motion controller, where these data messages do not pass through the software user interface.

Besides direct electronic communication between modules, another principal difference between the decoupled scanning apparatus 50 of FIG. 2 and the coupled scanning apparatus 10 of FIG. 1 is that in the decoupled apparatus 50 embodiment that is depicted in FIG. 2 most or, preferably, all of the bi-directional communication links operates using the same generic communication protocol. Various embodiments of decoupled systems may use such industry standard generic communication protocols as Transmission Control Protocol (TCP)/Internet Protocol (IP) (TCP/IP)—commonly known as the internet protocol suite, RS-422/485 serial communication protocol, RS-428 serial communication protocol, the universal serial bus (USB) protocol or standard TTL (transistor or transistor logic) signaling protocol. The term “industry standard communication connection protocol” as used herein refers to a data communication signaling protocol that has been defined by a standards committee having a membership that includes a plurality of equipment manufacturers and/or service providers that act as a governing body to define standardized technology practices. An “open standard communication connection protocol” is an industry standard communication connection protocol that may be freely used by any equipment manufacturer or service provider either free of charge or by payment of a standard usage fee that has the same basis for all users. The previously identified examples of industry standard communication connection protocols are also examples of open standard communication connection protocols. Many of the original communication connection protocols developed by NOVELL™, DIGITAL EQUIPMENT CORPORATION™, and XEROX CORPORATION™ were industry standard communication connection protocols that, at the time they were developed, were not “open standard communication connection protocols.” However in recent years access to those protocols has become generally available so that at least some versions of those protocols are now open standard communication connection protocols.

Note that the terms “industry standard communication connection protocol” and “open standard communication connection protocol” refer to standardized communication signaling rules. The format of actual data messages that are communicated between modules using such standardized communication rules may vary from module manufacturer to module manufacturer. For example, two module manufacturers may use the same open standard generic communication protocol (e.g., RS422/485) to communicate encoder position data, but one manufacturer may specify a data message format of 20 words (e.g., four blocks of five words) to communicate encoder position information using that open standard communication connection protocol, whereas the other manufacturer may specify a different data message format using the same open standard communication connection protocol.

Preferably different manufacturers may utilize an industry standard data message format. As used herein, the term “industry standard data message format” refers to a message format that has been defined by a standards committee having a membership that includes a plurality of equipment manufacturers and/or service providers that act as a governing body to define standardized technology practices. An “open standard data message format” refers to an industry standard data message format that may be freely used by any equipment manufacturer or service provider either free of charge or by payment of a standard usage fee that has the same basis for all users. An example of an open standard data message format is the Modbus Protocol. Modbus Protocol is a messaging structure using standardized “Request,” “Indication,” “Response,” and “Confirmation” data message formats to establish communication between intelligent devices. An open standard data message format may be combined with an open standard communication connection protocol. An example of such a combination is the Modbus TCP/IP protocol.

In many embodiments of decoupled scanning apparatuses the direct electronic communication link between modules uses at least one signal routing device such as a communication ring, a hub, a switch, a router or a gateway to provide the direct electronic communication link from a transmitting module to a selected receiving module. Such devices are referred to herein as “networking modules.” Because of the flexibility provided by a decoupled system using a networking module it is relatively easy to modify and adapt a de-coupled scanning system for a new configuration and purpose to which it was not originally designed.

In some embodiments of scanning systems some or all of the individual modules may be mounted in a gantry frame and an object to be scanned may be placed adjacent (typically inside) the gantry frame. In some embodiments of scanning systems some or all of the modules may be mounted on a track. In order to scan the object, the scanning apparatus is generally configured to provide relative motion between the object and the rotating collimator, either by moving the object or the collimator in the gantry frame system, or by moving the rotating collimator on a track in a track system. In some embodiments the rotating collimator may be configured to turn or oscillate about an axis perpendicular to the axis of rotation of the rotating collimator. It is to be understood that references herein to a “turning” motion include an “oscillating” motion. In some embodiments of scanning systems the rotation rate of the rotating collimator may be variable and synchronized internally with corresponding feedback signals (synchronization trigger signals) being generated by the rotating collimator and sent to one or more other modules so that those modules know the rotational phasing of the rotating collimator. This is an example of a synchronization trigger signal coming from a hardware synchronization trigger device. Other examples include optical triggers, mechanical triggers, magnetic triggers, resolvers, encoders, and/or anything that takes a physical location and produces a signal based on an event at such physical location. In some embodiments the rotation rate of the rotating collimator may be variable and may be synchronized by a synchronizing signal generated by a module (such as the motion control module) and sent to the rotating collimator module.

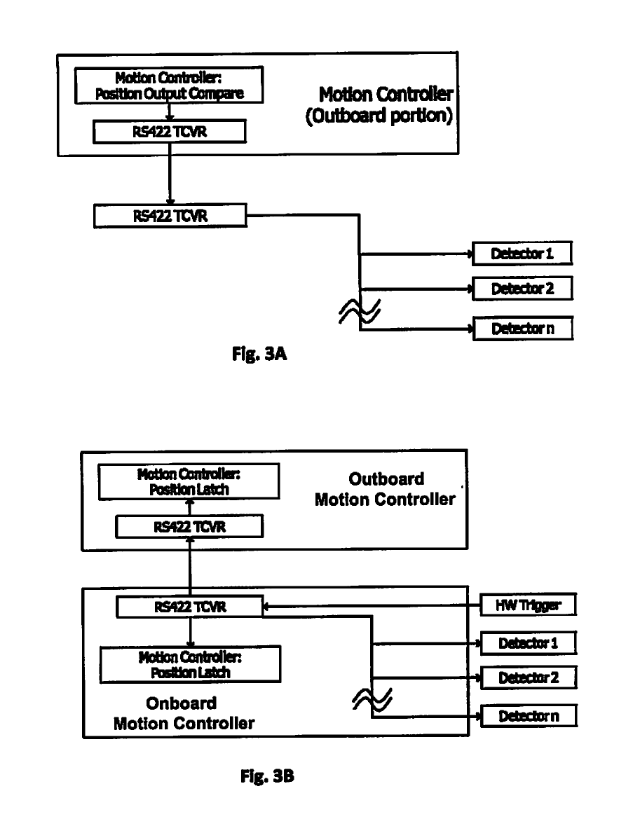

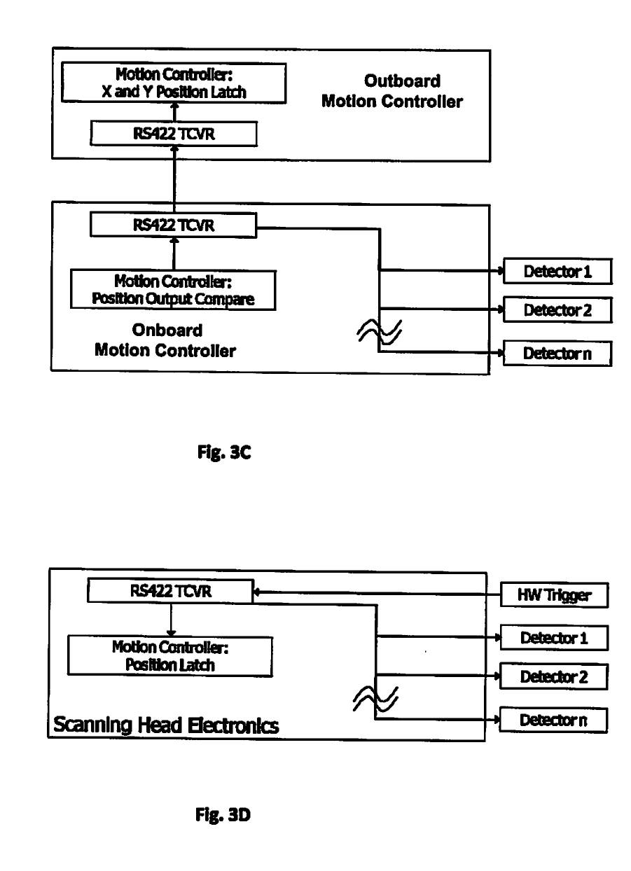

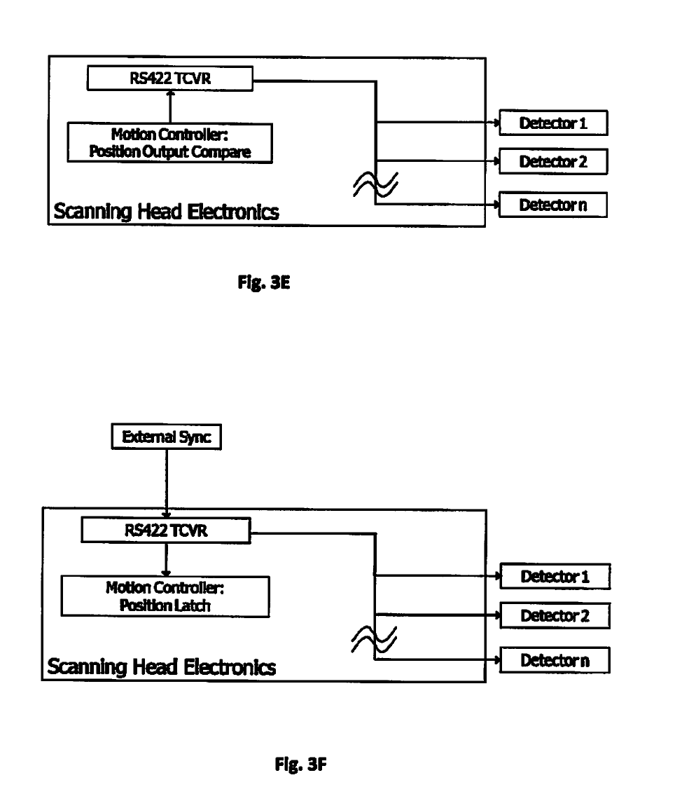

FIGS. 3A-3H provide examples of various communication techniques in decoupled systems embodying some combinations of these different mounting and operational configurations. In FIGS. 3A-3H the direction of the arrows between the block diagram elements represents the direction of a synchronization signal. The notation “RS422 TCVR” refers to a data transceiver operating with RS422 protocol.

FIG. 3A shows components of an embodiment of a scanning apparatus operating along a gantry frame where the rotating collimator is mounted inside the gantry frame and the rotating collimator does not turn or oscillate about an axis perpendicular to its axis of rotation. The scanning apparatus includes a data acquisition component, a motion control component, and a user interface component. The motion control component includes at least one motion controller. In such embodiment the at least one motion controller typically provides a single motion profile (i.e., a single scanning pattern format) or a particular motion profile is selected via the user interface component, and the motion controller operates as a synchronization source. The Position Output Compare function of FIG. 3A provides a synchronizing signal, typically using an encoder feedback signal as input. The encoder feedback may originate from the rotating collimator or the positional drive system, and the encoder feedback signal may be created by such sources as a motor output counter, a motor encoder, a liner variable differential transformer (LVDT) or other position transducer. When the encoder feedback hits a predetermined value the motion controller transmits a synchronizing output in a predetermined sequence which (in the embodiment of FIG. 3A) is used by the detectors to determine when to start and stop recording radiation data detected by the data acquisition component. Typically the synchronizing signal aligns the data measurement to a known physical point in space. The same synchronizing signal is preferably transmitted simultaneously to all detectors so that all the detectors start taking measurements at the same time.

FIG. 3B shows components of an embodiment of a scanning apparatus operating along a gantry frame where the collimator may turn or oscillate around an axis perpendicular to its axis of rotation. In such embodiments the motion controller is typically capable of providing multiple motion profiles, meaning that the scanning pattern formats may be varied under program control based on, for example, input to a user interface component. The scanning apparatus in FIG. 3B also includes a data acquisition component and a motion control component. In this embodiment the detectors and the rotating collimator are integrated into a scanning head and the scanning head is mounted inside the gantry framework. In the embodiment of FIG. 3B the motion control component includes a “outboard” motion controller that is typically mounted on the gantry framework and an “onboard” motion controller that is mounted in, on, or adjacent the scanning head. The outboard motion controller may receive encoder input from motors or other hardware in the positional drive system, which identifies a current encoder position.

The HW (hardware) trigger of FIG. 3B is a hardware device that triggers when a predetermined physical event happens. For example, the HW trigger may include an optic trigger that senses holes drilled in the rotating collimator, or the HW trigger may include a magnetic trigger that senses magnets placed on the rotating collimator. A magnetic hardware trigger, for example, may be used with scanning system where a non-rotating x-ray beam runs along a track, and a magnetic detector detects magnets that are placed along the track.

In the embodiment of FIG. 3B, a pulse signal from a hardware trigger is sent both to the outboard motion controller and to the onboard motion controller. As will be recognized by a person of ordinary skill in the art, the term “position latch” refers to a synch pulse instructing a module to capture a current encoder position when the synchronization pulse is received. The position latch functions in both the outboard motion controller and the inboard motion controller and is typically only used to provide a check confirming the position of all the motion axes when the data acquisition component begins taking data. If there is a discrepancy between the position that a motion controller has directed a motor drive system to establish through a positional drive system and the rotating collimator, the position latch data may be used to adjust any mechanical distortion in the image. This becomes more important when multiple axes are moving at the same time while scanning.

FIG. 3C shows components of an embodiment of a scanning apparatus operating along a gantry frame where the collimator may turn or oscillate around an axis perpendicular to its axis of rotation to, for example, provide a yaw motion. The scanning apparatus in FIG. 3C includes a data acquisition component, a motion control component, and a user interface component. The embodiment of FIG. 3C does not employ a hardware trigger. Instead, the synchronizing signal is provided by a Position Output Compare function, similar to that described with respect to FIG. 3A except that in the embodiment of FIG. 3C the onboard motion controller generates the synchronizing signal, typically using an encoder feedback signal as input. The synchronizing signal is sent to the outboard motion controller where it triggers a position latch function that captures a current encoder position when the synchronizing pulse is received. As with the previously-described position latching operation, this function may be used to correct distortion in a scanning image resulting from mechanical errors.

FIG. 3D shows components of an embodiment of a scanning apparatus. The scanning apparatus in FIG. 3D includes a data acquisition component, a motion control component, and a user interface component. The motion control component includes a motion controller that is built into a scanning head. This configuration may be used in scanning apparatuses where the data acquisition component and the rotating collimator are attached to the scanning head which is then attached to a mounting fixture that may be stationary or may be part of an independently-operated motion system. Such configurations may also be used in a track-based scanning apparatuses. In a track-based apparatus the detectors and x-ray emission source are preferably attached to the scanning head and the scanning head is then attached to rolling cart on a linear track. The linear track provides scanning motion along a linear translation axis, a rotating collimator provides scanning motion along a rotational axis that is substantially parallel to the linear translation axis, and swiveling hardware on the cart may provide further rotational scanning motions such as pitch, yaw, or roll. The scanning head communication configuration of FIG. 3D is basically the same as the scanning head communication configuration of FIG. 38, but all of the motion control functions are performed onboard. In the case of a track-based scanning system, there is no need to send a synchronizing signal to an outboard portion of a motion controller. Instead, the rolling cart houses the motor driver, the rotating collimator, and the linear drive system to create the entire scanning motion.

FIG. 3E shows components of an embodiment of a scanning apparatus. The scanning apparatus in FIG. 3E includes a data acquisition component, a motion control component, and a user interface component. The motion control component includes a motion controller that is built into a scanning head similar to the embodiment illustrated in FIG. 3D. This embodiment is similar to the embodiment of FIG. 3C in that the embodiments of FIGS. 3C and 3E do not employ a hardware trigger. However, unlike the embodiment of FIG. 3C, in the embodiment of FIG. 3E, no synchronizing signal is sent to an outboard portion of the motion controller. The embodiment of FIG. 3E may be used in the same types of systems discussed with respect to the embodiment of FIG. 3D.

FIG. 3F shows components of an embodiment of a scanning apparatus where a synchronizing signal is generated externally by an external synchronization source and provided to a scanning head. The scanning apparatus in FIG. 3F includes a data acquisition component, a motion control component, and a user interface component. The external synchronization source may be a fixed interval clocking signal such as, for example, a timing data message that is transmitted every 100 milliseconds.

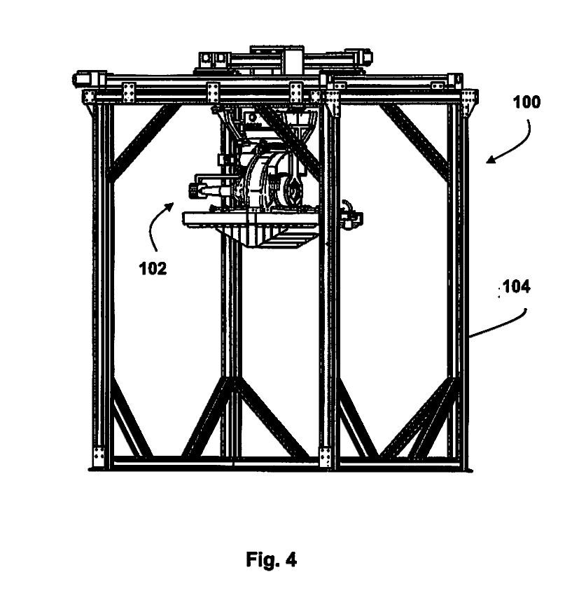

FIG. 4 shows a perspective view of an embodiment of a scanning apparatus 100 including a scanning head 102. The scanning apparatus 100 is mounted on (or, optionally, includes) a gantry frame 104.

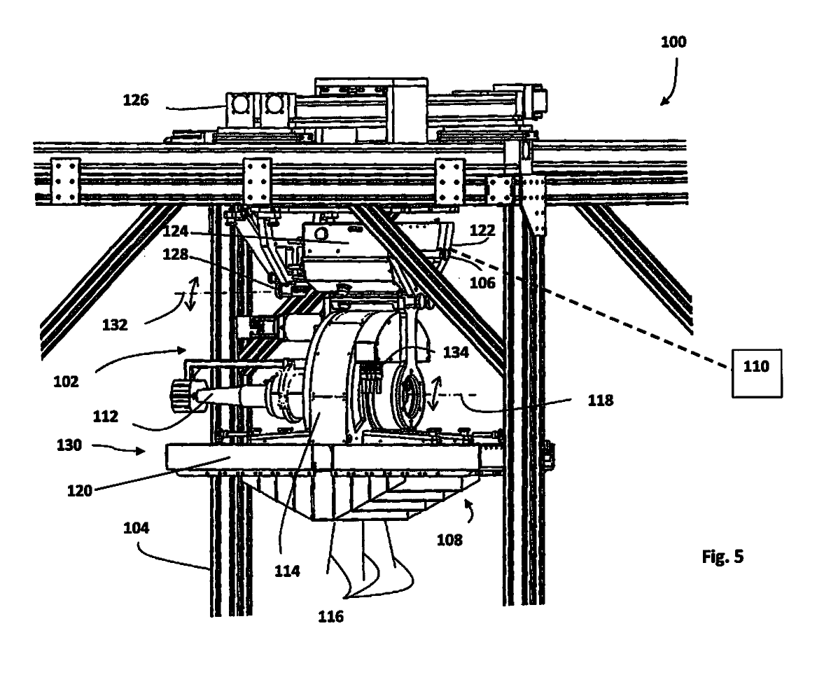

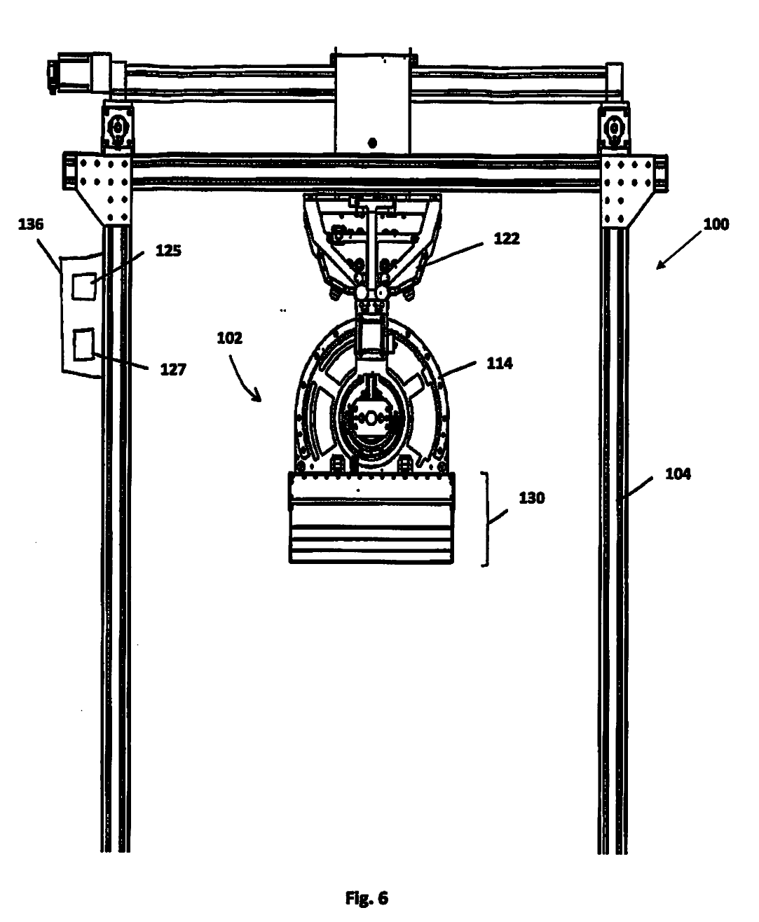

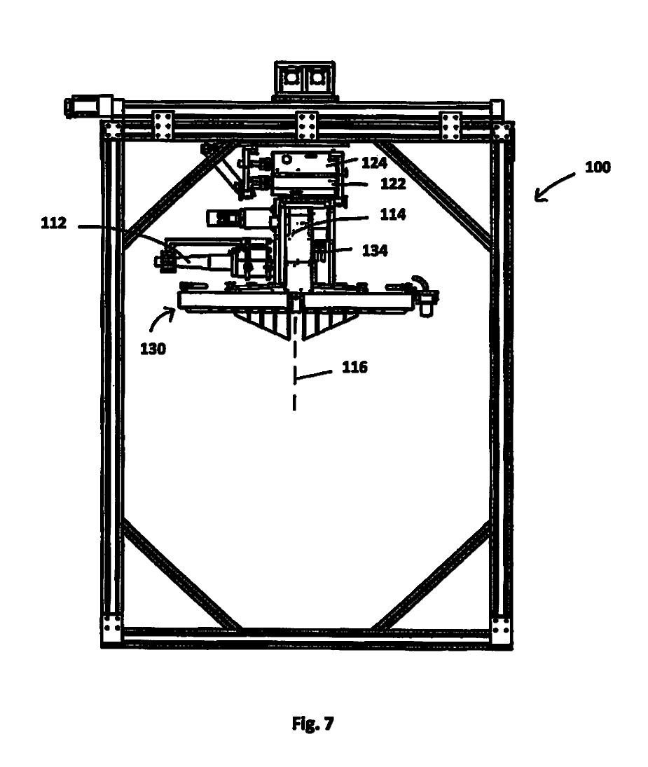

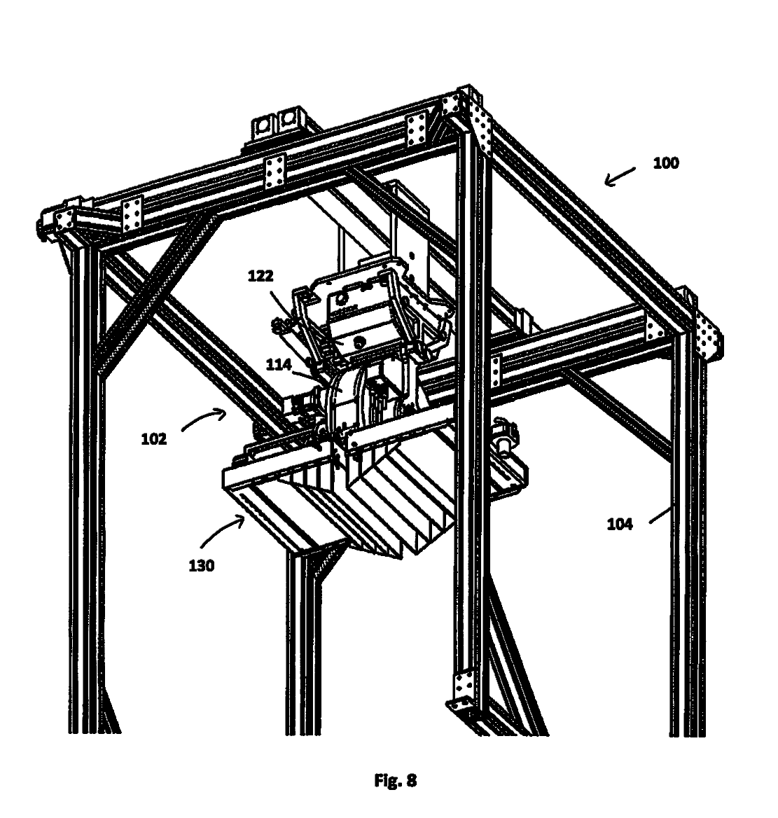

FIGS. 5-8 depict close-up views of the scanning apparatus 100 shown in FIG. 4 including a motion control component 106, a data acquisition component 108, and a user interface component 110. The data acquisition component 108 includes the scanning head 102 which further includes an penetrating radiation emission (e.g., X-ray) source 112 for a rotatable collimator 114 that emits, for example, pencil beam X-ray scan line traces 116 about a spin axis 118 to scan a target object. The combination of the X-ray source 112 and the rotatable collimator 114 is an example of an imaging scanning source. Substantially when the X-ray scan line traces 116 impact the target object, Compton X-ray back-scattered energy is emitted or otherwise reflected by the object and detected as imagery elements by one or more detectors 120 which form part of the data acquisition component 108. In the embodiment shown in FIGS. 4-6, the scanning head 102 further includes an onboard motion controller 122 including a motor driver system 124. The motor driver system 124 provides power, instructions, and/or data to a translational drive system 126 for moving the scanning head 102 to different locations on the gantry frame 104 and the motor driver system 124 provides power, instructions, and/or data to a rotational drive system 128 for oscillating the rotating collimator 114 and a detector array 130 about a roll axis 132. The combination of the translational drive system 126 and the rotational drive system 128 is an example of a positional drive system.

Communication with the onboard motion controller 122, the rotatable collimator 114, and the detector array 130 is provided, for example, through an Ethernet switch 134. The various components are preferably configured for communication using a plurality of different communication protocols such as for example, TCP/IP, USB, SPX/IPX, and other similar protocols. In this way, the various components may be used (or left out) as necessary based on the condition of a separate, less flexible, coupled system as described with respect to FIG. 1.

In a related embodiment, the motion controller 122 is located separate from (e.g., up to about 50 meters away) the gantry frame and parts attached thereto. In such an embodiment, the motion controller 122 would be classified as an off-board motion controller. In yet another embodiment, the motion control component includes the onboard version of the motion controller 122 and a second motion controller 136 attached adjacent the gantry frame 104. In this embodiment, the second motion controller 136 includes a second motor driver system 125 and a second translational drive system 127 wherein, for example, the second motor drive system 125 can provide power, instructions, and/or data to the translational drive system 127 for moving the scanning head 102 to different locations on the gantry frame 104. Other embodiments including a plurality of motion controllers, some or all of which are configured in duplicate for the same tasks, are contemplated herein due to the ease at which various components can communicate with one another and/or can be interchanged with one another. Instructions from the user interface component 110 can be used to determine which parts (e.g., motor controllers) are to be used for what functions (e.g., translational motion, rotational motion, or other motion regime). The de-coupled nature of the components described in this and related embodiments allows the various components (i.e., the motion control component 106, the data acquisition component 108, and the user interface component) to be retrofitted to prior-existing equipment or fitted to heretofore unimagined equipment. This is due to the flexibility of the components which includes their ability to communicate using various communication protocols and the fact the particular positioning of these components on various hardware configurations is so accommodating to virtually any multidimensional structure.

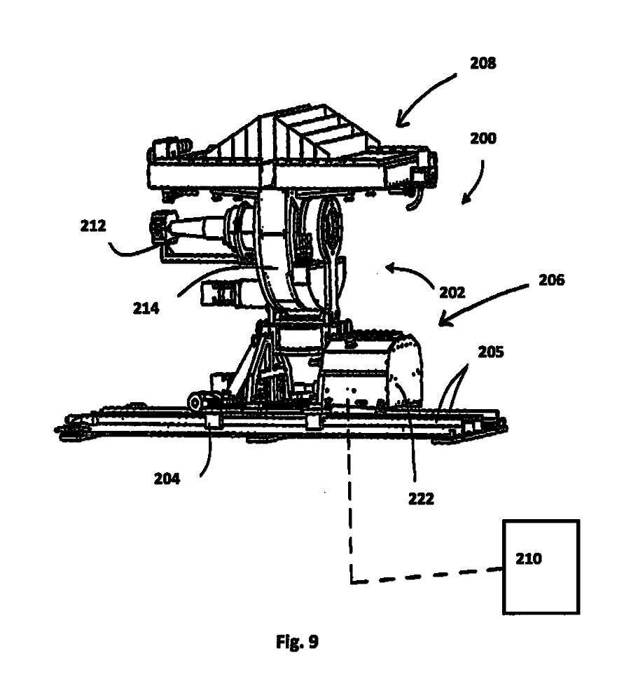

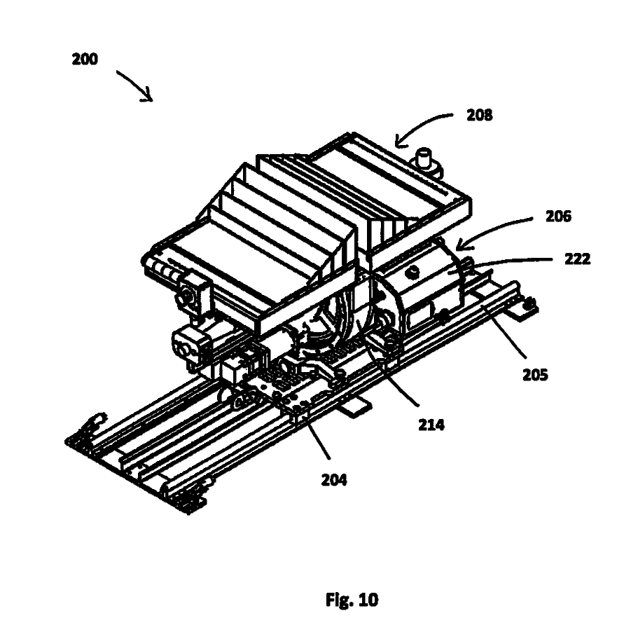

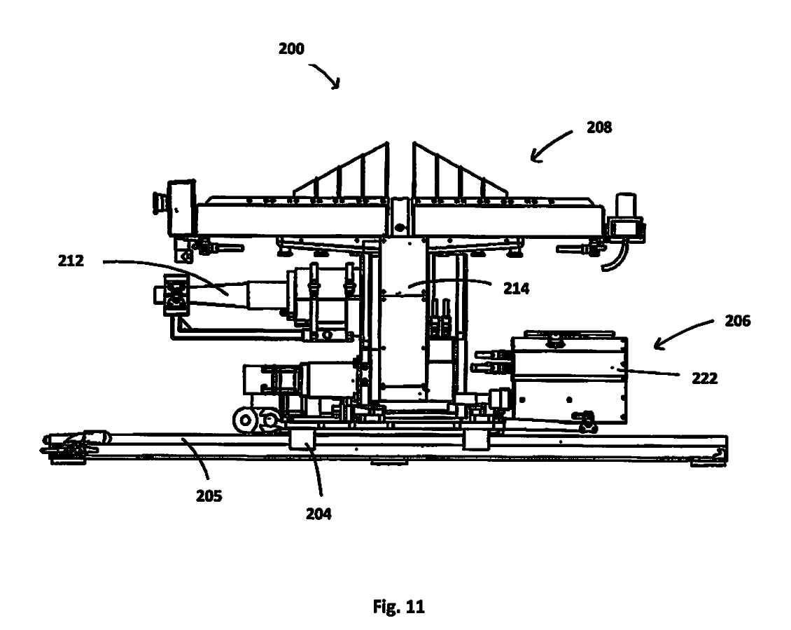

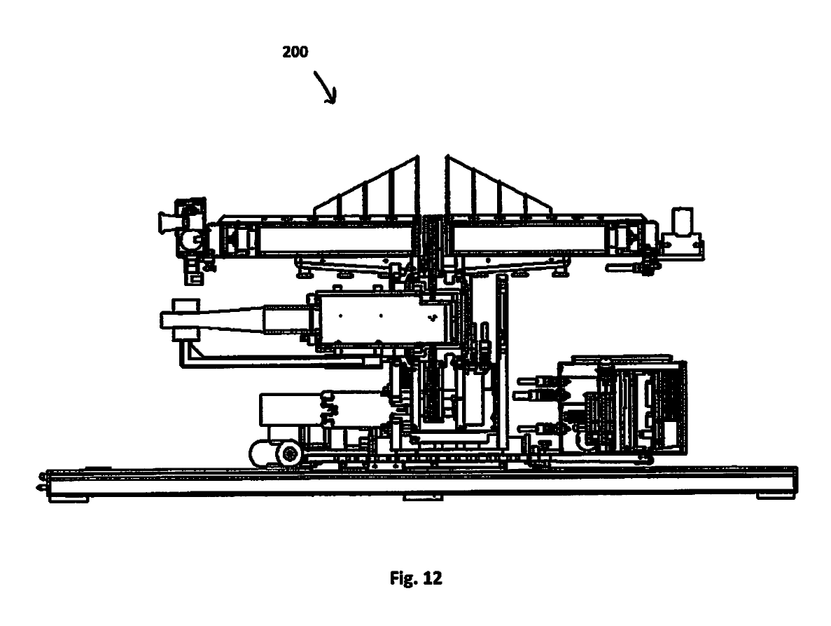

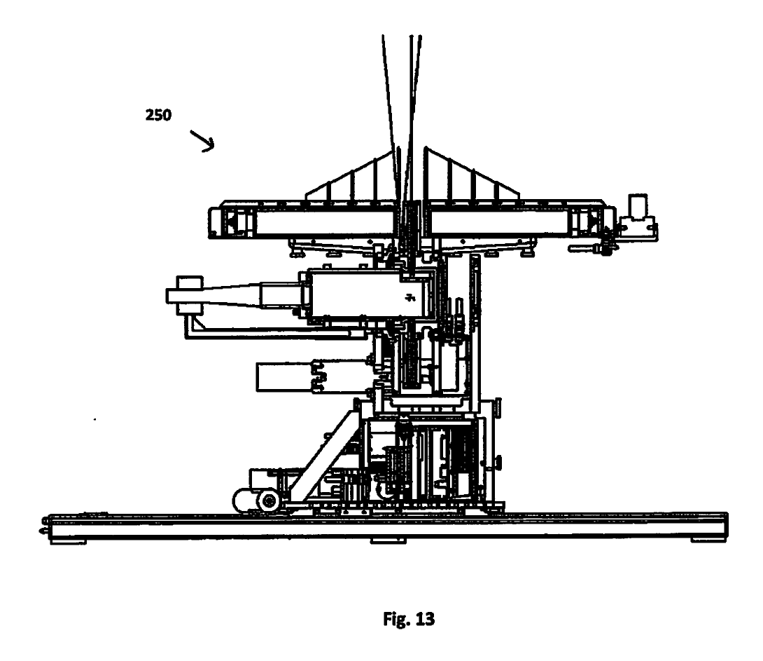

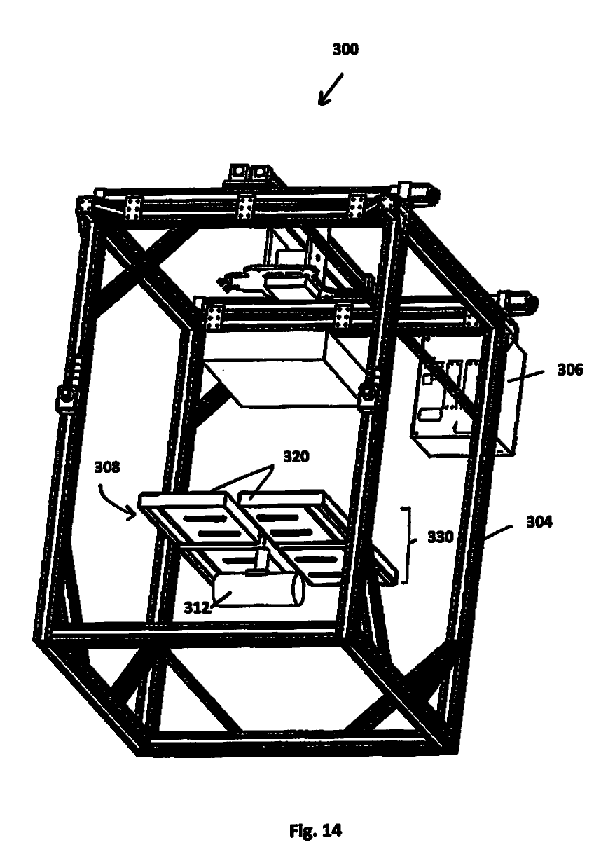

FIGS. 9-12 illustrate a track-based scanning apparatus 200 including a motion control component 206 including at least one motion controller 222, a data acquisition component 208, and a user interface component 210. The track-based scanning apparatus 200 includes a scanning head 202 that is mounted on a sled 204 that glides on rails 205. In this embodiment, the at least one motion controller 222 is in an “onboard” position on the sled 204. The scanning head 202 includes a penetrating radiation emission (e.g., X-ray) source 212 and a rotating collimator 214. The X-ray source 212 and the rotating collimator 214 are an example of an imaging scanning source. The sled 204 and the rails 205 are an example of a frame for positioning an imaging scanning source in a plurality of locations adjacent a target object to be scanned. The components of the scanning apparatus 200 are similar or identical to the components of the scanning apparatus 100 of FIGS. 4-8 except that the apparatus 100 of FIGS. 4-8 scans from a raised position whereas the track-based scanning apparatus 200 of FIGS. 9-12 scans in a direction relative to the positioning of the track 205 itself. FIG. 12 shows a cross-sectional view of the scanning apparatus shown in FIGS. 9-12. FIG. 13 shows a side view of a track-based scanning apparatus 250 wherein the at least one motion controller 222 (not shown) of the motion control component 206 is in an “offboard” as opposed to the onboard views shown in FIGS. 9-12.

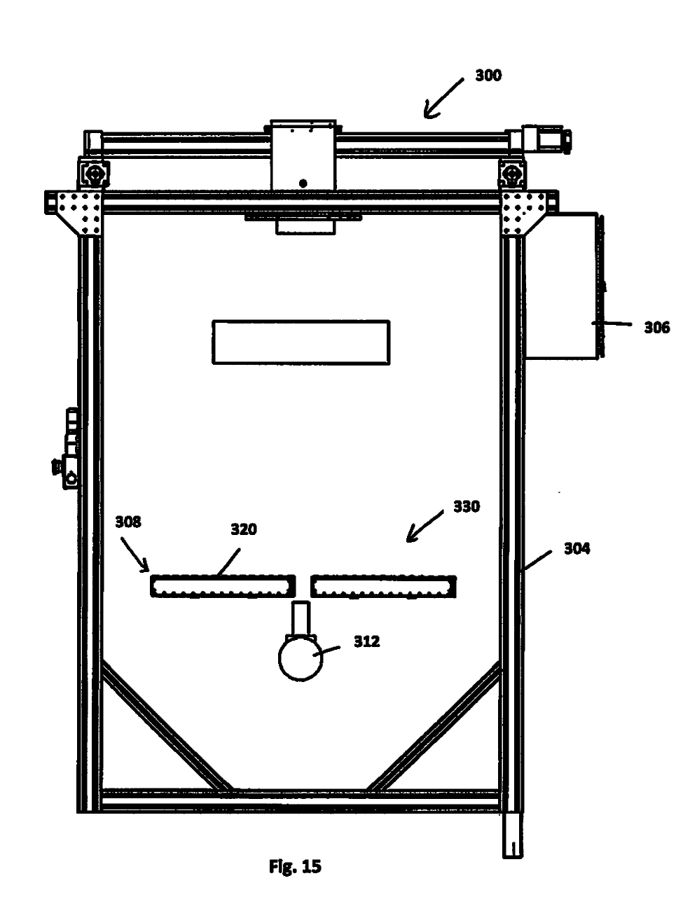

FIGS. 14-15 show two views of a scanning apparatus 300 including a motion control component 306 and a data acquisition component 308 attached adjacent a gantry frame 304. In this embodiment, one or more detectors 320 of the data acquisition component 308 remain stationary (relative to a common ground surface including, for example, the Earth's surface or the bed of a moving truck) while a target object moves. The moving target object is scanned using a penetrating radiation emission source 312 and a detector array 330 as in similar embodiments described above wherein the target object remained stationary. The exact structure used to hold the emission source 312 and the one or more detectors 320 is not particularly important so long as these portions of the scanning apparatus 300 are held substantially firmly in place.

Other embodiments are contemplated wherein both a target object and one or more portions of the scanning apparatus 300 move relative to Earth's surface during scanning.

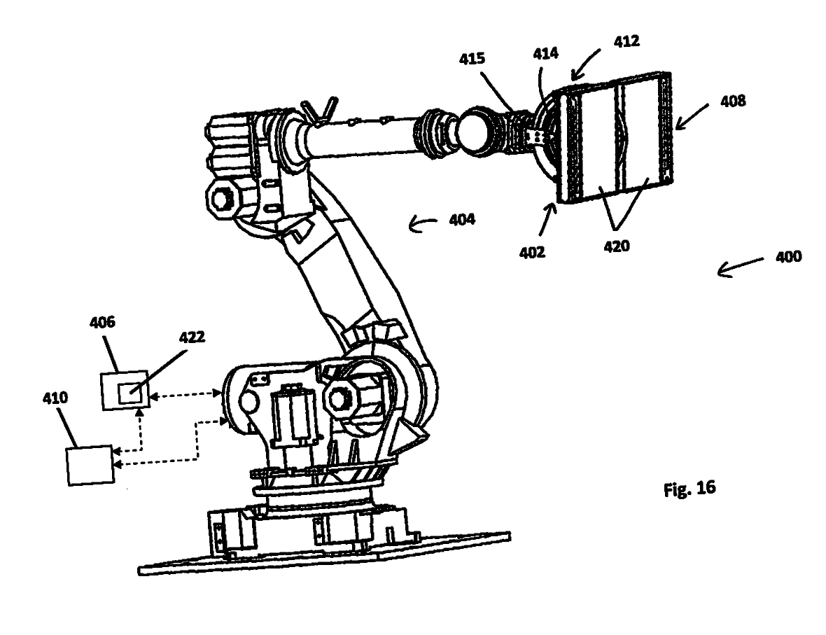

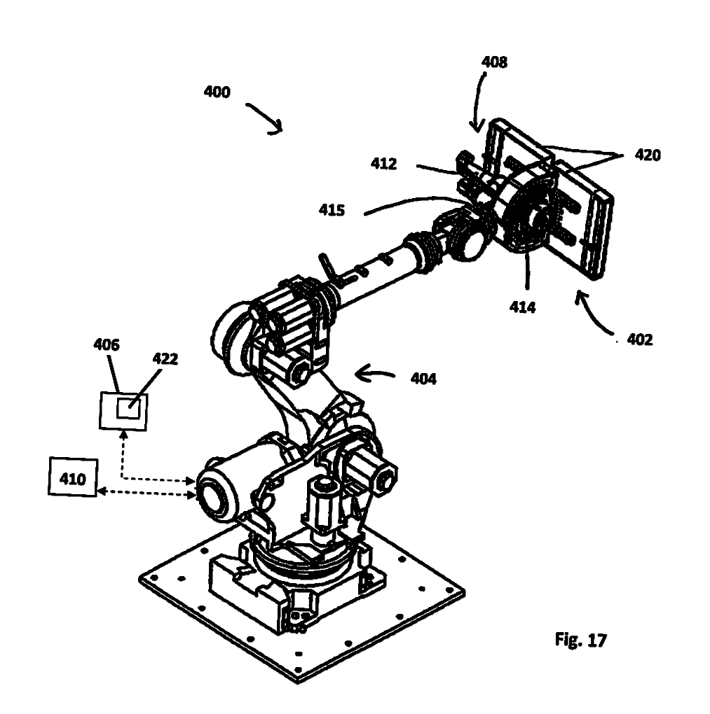

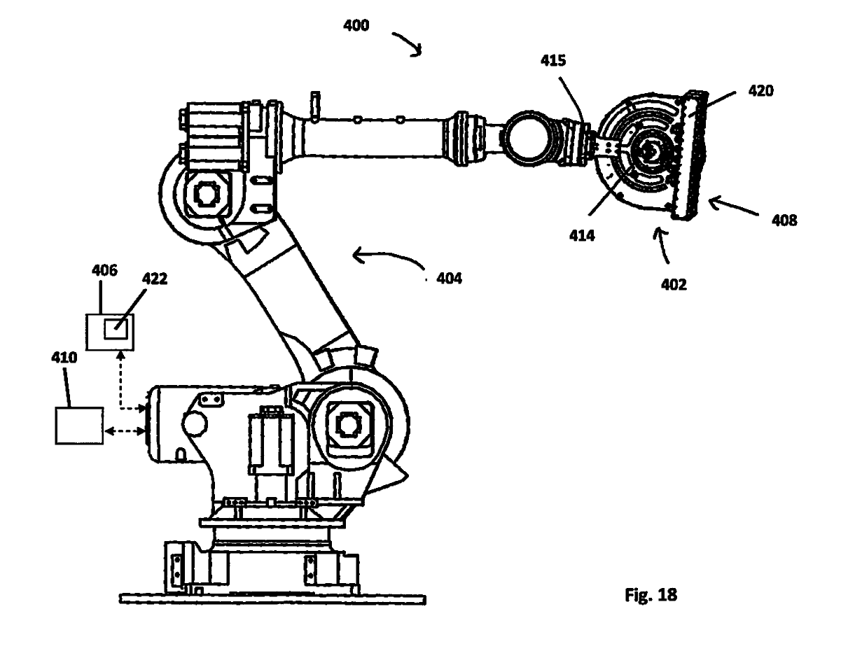

FIGS. 16-18 show various views of an embodiment of a scanning apparatus 400 including a motion control component 406 including at least one motion controller 422, a data acquisition component 408 including one or more detectors 420, a user interface component 410, a robotic arm 404, a penetrating radiation emission source 412 in the form of a rotatable collimator 414, and a scanning head 402 including the one or more detectors 420 and the penetrating radiation emission source 412. The scanning head 402 is attached to a distal end 415 of the robotic arm 404 so that the scanning head 402 can be positioned at virtually any angle relative to a fixed point in space. More specifically, the inclusion of a robotic arm 404 which includes at least three rotatable axes provides the flexibility for the scanning head 402 to be positioned at virtually any theoretical Euler angle of rotation.

As is evident from this disclosure, the precise motion profile and/or hardware used in conjunction with the various apparatuses described herein is virtually unlimited. What most of the embodiments described herein have in common includes a penetrating radiation emission source, a data acquisition component including one or more detectors, a motion control component including one or more motion controllers, a penetrating radiation emission exit port wherein penetrating radiation generated by the penetrating radiation emission source exits the imaging apparatus therefrom, a scanning head including the one or more detectors and the penetrating radiation emission exit port wherein the scanning head is movable in response to one or more signals from the one or more motion controllers, and a user interface component. In these embodiments, the data acquisition component, the motion control component, and the user interface component are configured for communication, including receiving and/or sending instruction sets, using a plurality of generic communication protocols whereby the scanning head can be integrated with equipment configured for numerous motion profiles and communication protocols. (In certain embodiments, the scanning head includes the penetrating radiation emission source.)

Furthermore, the data acquisition component, the motion control component, and the user interface component are configured for using a plurality of generic motion control standards such as, for example, Modbus Protocol. Also, the data acquisition component and the motion control component are preferably configured for using a plurality of generic synchronization protocols wherein each such synchronization protocol provides tight spatial and temporal control of instruction sets to provide an accurate image of the scanned target object. The phrase “tight spatial and temporal control” is meant to connote spatial tolerance ranges based on today's current imaging and positioning technology of from about 1 micron to about 2000 microns. The phrase “tight spatial and temporal control” is also meant to connote temporal tolerance ranges measured, for example, anywhere from picoseconds range to a range measured in seconds. Of course, the precise tolerance ranges will depend on the particular application with which the particular scanning apparatus and/or parts thereof is to be used. Current embodiments include nanosecond timing control, micron positioning control and pixel dwell times that range from microseconds to seconds. Resolution ranges from measurements made in microns to measurements made in centimeters. Although present embodiments described herein have specific spatial and temporal ranges as described based on present technology, embodiments of the invention are not necessarily limited to any particular tolerance range(s), particularly in light of (1) the vast number of different types of target objects to be scanned and (2) how rapidly scanning technologies improve to smaller and smaller value ranges.

In summary, embodiments disclosed herein provide various systems for scanning an object. The foregoing descriptions of embodiments have been presented for purposes of illustration and exposition. They are not intended to be exhaustive or to limit the embodiments to the precise forms disclosed. Obvious modifications or variations are possible in light of the above teachings. The embodiments are chosen and described in an effort to provide the best illustrations of principles and practical applications, and to thereby enable one of ordinary skill in the art to utilize the various embodiments as described and with various modifications as are suited to the particular use contemplated. All such modifications and variations are within the scope of the appended claims when interpreted in accordance with the breadth to which they are fairly, legally, and equitably entitled.

What is claimed is:

1. An imaging apparatus including modular, interchangeable components for single sided non-destructive inspection of a target object using one or more penetrating radiation emission and backscatter detection technologies, the imaging apparatus comprising a penetrating radiation emission source, a data acquisition component in communication with a user interface component via a first generic communication protocol, and a motion control component including a motion controller, the motion control component in communication with the user interface component via a second generic communication protocol, wherein the data acquisition component is in communication with the motion control component via a third generic communication protocol, and wherein the data acquisition component and the motion control component are synchronized in response to a synchronization trigger signal.

2. The imaging apparatus of claim 1 wherein the data acquisition component further comprises a detector for detecting penetrating radiation emitted from the penetrating radiation emission source, and wherein the motion control component further comprises a first motion controller and a second motion controller.

3. The imaging apparatus of claim 1 wherein the first generic communication protocol and the second generic communication protocol comprise a protocol selected from the group consisting of TCP/IP protocol, USB protocol, and SPX/IPX protocol.

4. The imaging apparatus of claim 1 wherein the first generic communication protocol, the second generic communication protocol, and the third generic protocol comprise the same generic communication protocol.

5. The imaging apparatus of claim 1 wherein the data acquisition component and the motion control component are synchronized by a synchronization signal protocol comprising the protocol selected from the group consisting of TTL, RS-422/485, and RS-428.

6. The imaging apparatus of claim 1 wherein the penetrating radiation emission source comprises an X-ray emission device.

7. The imaging apparatus of claim 2 wherein the data acquisition component, the motion control component, and the user interface component are each separately configured for the first motion controller, the second motion controller, a hardware synchronization trigger device, or an external input source to operate as a synchronization instruction source depending on instruction from the user interface component.

8. The imaging apparatus of claim 2 further comprising a cross beam including a first transport feature, wherein the penetrating radiation emission source is attached adjacent the first transport feature so that the penetrating radiation emission source is movable relative to the cross beam along the first transport feature in response to instruction from the motion control component.

9. The imaging apparatus of claim 2 further comprising a scanning head for emitting penetrating radiation and detecting backscattered penetrating radiation, the scanning head comprising a penetrating radiation emission exit port and the at least one detector.

10. The imaging apparatus of claim 7 wherein the hardware trigger synchronization device comprises a device selected from the group consisting of an optical trigger, a mechanical trigger, a magnetic trigger, a resolver, and an encoder.

11. The imaging apparatus of claim 8 wherein the detector is attached adjacent the first transport feature so that the penetrating radiation emission source and the detector is movable relative to the cross beam along the first transport feature in response to instruction from the motion control component.

12. The imaging apparatus of claim 8 further comprising a scanning head for emitting penetrating radiation and detecting backscattered penetrating radiation, the scanning head comprising the detector and the penetrating radiation emission source, wherein the scanning head is attached adjacent the first transport feature via a movable joint wherein the scanning head is movable based on movement of the movable joint in response to instruction from the motion control component.

13. The imagining apparatus of claim 9 further comprising a cross beam including a first transport feature, wherein the scanning head is attached adjacent the first transport feature so that the scanning head is movable relative to the cross beam along the first transport feature in response to instruction from the motion control component.

14. The imaging apparatus of claim 9 further comprising a robotic arm including a first end wherein the scanning head is attached adjacent the first end of the robotic arm, wherein the movement of the robotic arm is controlled by the at least one motion controller.

15. The imagining apparatus of claim 12 further comprising a gantry frame including the cross beam; a first side beam and a second side beam oriented substantially perpendicular to the cross beam wherein the side beams support the cross beam; and a plurality of support beams supporting the side beams; wherein the first side beam includes a second transport feature attached adjacent a first end of the upper cross beam, and wherein the second side beam includes a third transport feature attached adjacent a second end of the cross beam; and wherein the cross beam is movable relative to the first side beam and the second side beam in response to instruction from the motion control component.

16. The imagining apparatus of claim 13 wherein the scanning head is attached adjacent the first transport feature via a movable joint wherein the scanning head is movable based on movement of the movable joint in response to instruction from the motion control component.

17. The imagining apparatus of claim 15 further comprising a gantry frame including the cross beam; a first side beam and a second side beam oriented substantially perpendicular to the cross beam wherein the side beams support the cross beam; and a plurality of support beams supporting the side beams; wherein the first side beam includes a second transport feature attached adjacent a first end of the upper cross beam, and wherein the second side beam includes a third transport feature attached adjacent a second end of the cross beam; and wherein the cross beam is movable relative to the first side beam and the second side beam in response to instruction from the motion control component.

18. The imaging apparatus of claim 16 wherein the robotic arm has at least three rotatable joints wherein substantially all Euler angles of rotation are achievable to position the scanning head for scanning a target object.

19. The imaging apparatus of claim 17 wherein the scanning head further comprises the penetrating radiation emission source.

20. An imaging apparatus including modular, interchangeable components for single sided non-destructive inspection of a target object using one or more penetrating radiation emission and backscatter detection technologies, the imaging apparatus comprising a penetrating radiation emission source, a data acquisition component including a detector, a motion control component including a motion controller, a penetrating radiation emission exit port wherein penetrating radiation generated by the penetrating radiation emission source exits the imaging apparatus therefrom, a scanning head including the detector and the penetrating radiation emission exit port wherein the scanning head is movable in response to one or more signals from the motion controller, and a user interface component; wherein the data acquisition component, the motion control component, and the user interface component are configured for communication, including receiving and/or sending instruction sets, using a plurality of generic communication protocols whereby the scanning head can be integrated with various equipment configured for different motion profiles and communication protocols; wherein the data acquisition component, the motion control component, and the user interface component are configured for using a plurality of generic motion control standards; and wherein the data acquisition component and the motion control component are configured for using a plurality of generic synchronization protocols wherein each such synchronization protocol provides spatial and temporal control of the instruction sets in order to provide an accurate image of the scanned target object.
